(19) United States
(12) Patent Application Publication
(10) Pub. No.: US 2012/0010865 A1
(43) Pub. Date: Jan. 12, 2012

(54) Reservoir Quality Characterization Using Heterogeneity Equations With Spatially-Varying Parameters

(76) Inventor: Gregory S. Benson, Kingwood, TX (US)

(21) Appl. No.: 13/146,180

(22) PCT Filed: Dec. 14, 2009
(86) PCT No.: PCT/US2009/067919

§ 371 Date: Jul. 25, 2011

Related U.S. Application Data
(60) Provisional application No. 61/164,224, filed on Mar. 27, 2009.

(51) Int. Cl. G06G 7/48

(52) U.S. Cl. 703/10

(57) ABSTRACT

A method is disclosed wherein an expression is selected to approximate measurement-based values of a geologic attribute along a dimension of a subsurface formation as a function of position along the dimension. Values for terms of the expression are determined such that the expression satisfies an objective function to within a predetermined amount. The objective function indicates a difference between outputs of the expression and the measurement-based values at similar points along the dimension. The expression and the values of the terms of the expression are outputted, which includes mapping the terms of the expression to represent the geologic attribute in the subsurface formation such that the geologic attribute is described at all locations in the subsurface formation using the expression and the values of the terms of the expression.

### CROSS-REFERENCE TO RELATED APPLICATION

This application claims the benefit of U.S. Provisional Patent Application 61/164,224 filed 27 Mar. 2009 entitled RESERVOIR QUALITY CHARACTERIZATION USING HETEROGENEITY EQUATIONS WITH SPATIALLY-VARYING PARAMETERS, the entirety of which is incorporated by reference herein.

### TECHNICAL FIELD

Disclosed aspects relate generally to geologic modeling, and more specifically, to computer-based systems and methods that allow formation of a geologic model of a subsurface region of interest, such as a sedimentary basin or a petroleum reservoir.

### BACKGROUND OF THE DISCLOSURE

This section is intended to introduce various aspects of the art, which may be associated with embodiments of the invention. A list of references is provided at the end of this section and may be referred to hereinafter. This discussion, including the references, is believed to assist in providing a framework to facilitate a better understanding of particular aspects of the invention. Accordingly, this section should be read in this light and not necessarily as admissions of prior art.

A geologic model is a computer-based representation of a region of the earth subsurface. Such models are typically used to model a petroleum reservoir or a depositional basin. A geologic model commonly comprises a three dimensional (3-D) geocellular mesh that is composed of contiguous 3-D cells. Current reservoir modeling technology captures variations in reservoir properties by subdividing the subsurface of the Earth into relatively small volumes (e.g. cells 100 meters on a side and 25 centimeters thick) and storing several numbers in each cell to describe the spatial position and certain important rock quality descriptors or parameters for that small piece of the Earth. These numeric rock quality parameters typically include, but are not limited to, porosity, maximum and minimum horizontal permeability, compass direction of the maximum permeability, vertical permeability, water saturation, rock type proportions, and states of strain or deformation. Some kinds of rocks require many additional parameters to characterize the different types of chemical and physical alterations to the rock since the time of deposition, to quantify fracturing and its effects on reservoir performance, or to describe conditions unique to a specific field's geologic history.

After formation, the geologic model can be used for many purposes. One common use for the geologic model is as an input to a computer program that simulates the movement of fluids within the modeled subsurface region. These types of programs are used to predict, for example, hydrocarbon production rates and volumes from a petroleum reservoir over time.

One problem with known geologic modeling tools is that they do not capture information at scales smaller than the sizes of the physical dimensions of their finest spatial elements—the model cells. Known geologic models are designed to contain cells small enough that a single number for each cell can be reasonably expected to describe an average property within the real-world space that a cell is supposed to represent. A further consideration is that cell dimensions need to be about 50% the size of the smallest feature the model is designed to resolve. For example, to resolve a bed 20 centimeters thick, the model cells should be no thicker than 10 centimeters. In many hydrocarbon fields, this means that the cells need to be quite small in both horizontal and vertical dimensions to adequately capture the lateral and vertical changes in rock quality typically observed in geologic reservoir units. Consequently, the number of cells required to describe in detail a medium-sized field can be on the order of tens of millions of cells, and such large numbers of cells negatively impact computer processing times, memory usage, and storage space requirements. Models that are too large become impractical for use.

Well log data is the usual source of subsurface information used to populate geologic models. Well logs consist of regularly spaced data records along the length of a wellbore. The information is gathered using sensor tools suspended on cables or conveyed along the wellbore with drill pipe or other tubing. In wireline logging the tools are lowered to the bottom of the well and then raised up the wellbore while simultaneously recording the sensor signals.

The sensor tools measure physical properties of the rocks that are exposed along the wall of the wellbore. The measured properties include the speed of sound through the rocks, the ease with which electric current travels through the rocks, the radioactivity of the rocks, and the proportion of a neutron beam that is reflected back from the rocks. These measurements provide skilled analysts with sufficient information to calculate important properties of the reservoir, such as whether the rock is sand or mud, the amount of open space between the sand grains (porosity), and the amount of the open space that is occupied by gas, oil, and water (fluid saturation).

The wireline logs sense volumes of rock that are typically somewhat thicker than the spacing of the recorded samples, and thus these records reflect an average of the reservoir properties in the vicinity of the sample depth. This is the first stage of a process known as scale averaging of the true reservoir properties.

The properties assigned to geologic model cells are usually an average of two or more well log measurements because, in an effort to minimize the number of cells, the cells are defined as thicker than one wireline log sample. This averaging of wireline log values into geomodel cells, known as upscaling, is the second stage of scale averaging of the true reservoir properties (see FIG. 1). The choice of the geologic model cell size is a difficult compromise, and sometimes it is only after a geologic model is completed that it is discovered that an initial choice of model cell size was not optimum.

Geologic models may serve as a data source for production simulations, in which variations on well placement, recovery mechanisms, and enhancement techniques are simulated in a computer using equations that describe fluid flow through permeable media. These flow simulators perform complex, physics-based calculations of fluid flow divided into relatively short time spans, called time steps. Unfortunately, because the production history (or future prediction) may span many years, these simulation models require a great many time steps. This poses a problem because the large number of time steps combined with the large number of equations to be solved at each time step can cause flow simulations to run very slowly, if at all.

Minimizing the amount of time and computer resources required to run flow simulations requires some combination of reducing the number of time steps and reducing the number of cells being simulated. The simulation time step duration is usually varied automatically by the simulation algorithm solver according to the rate of fluid flow through the cells at each time step. The reliability of the algorithms is compromised when the amount of fluid entering and leaving a cell during a time step is too close to the total fluid storage capability of the cell. In practice, the only option for optimizing simulations is to reduce the number of cells being simulated. The operation in which geologic model cells are combined together into coarser simulation cells is called scale-up, and this is the third stage of scale averaging performed on the true reservoir properties. Scale-up can be as simple as mathematically averaging the properties of all of the geologic model cells that lie within the volume encompassed by the coarser simulation cells, or as complex as performing a calibration flow simulation on that group of geomodel cells to determine “effective flow properties” of the aggregate.

Discrepancies between the simulation and the actual field production history are commonly discovered during the reservoir simulation process. These discrepancies may be in observed fluid production rates, reservoir pressures, gas-oil ratios, and pressure-supporting injectant breakthrough times. When outputs of a reservoir simulator are not consistent with the known past history of a field, the simulator cannot be trusted to predict field behavior into the future. Corrections to the simulation model are required to improve the correlation with the known past history of the field. Sometimes these corrections can be accomplished entirely within the reservoir simulator software by modifying simulator inputs, such as transmissibility across a fault surface or bedding plane. Other times, analysis of these discrepancies reveals that the simulation model cells were not designed small enough to capture the detail necessary to duplicate known historic reservoir performance. To create finer simulation model cells, a new iteration of scale averaging of the source geologic model must be performed.

If the source geologic model was built at a sufficiently fine scale, making simulation cells of a smaller size can be accomplished by simply repeating the upscaling operation using new, smaller cell dimensions. However, if analysis reveals that the simulation cells should be made smaller than the source geologic model cells, the situation will be more difficult to remedy. The finest detail in the model was destroyed at the second stage of scale averaging when the wireline log samples within the cells were averaged together during the log-to-cell upscaling operation and single numbers were recorded for each geologic model cell. Repairing this problem requires going back to the beginning of the geologic modeling workflow, reestablishing a new smaller cell size for the model, re-determining the log-to-cell scale-averaged effective properties associated with the new cell dimension, and repopulating the new, smaller cells with the more finely defined cell properties. This is the case with all known geologic modeling techniques, which perform some kind of scale averaging of the wireline logs and store a single number for each property in each cell. When the need for finer detail in the geologic model is demonstrated through flow simulation, the geologic model must be rebuilt from scratch with smaller, more finely layered 3-D cells.

Rebuilding a geologic model to add more detail is a costly undertaking, possibly taking as long as the building of the original inadequate model, and often resulting in something so large and unwieldy that it cannot be used. The sheer number of geomodel cells required to capture this finer detail can itself become a problem by slowing down computer processing, consuming large volumes of computer disk space, and requiring impractical lengths of time to execute the construction processes. Worse, when geologic model cell counts rise above a certain threshold, the data volume will overwhelm the memory capacity of the computer on which the simulation is running, and the process of upscaling the source geologic model into simulation scale cells can fail. The need to rebuild a geologic model to add detail could be avoided if, from the beginning, the geologic model cells contained information about geologic features at a smaller scale than the chosen cell size.

The foregoing discussion of need in the art is intended to be representative rather than exhaustive. A technology addressing one or more such needs, or some other related shortcoming in the field, would benefit drilling and reservoir development planning, for example, providing decisions or plans for developing a reservoir more effectively and more profitably.

Other related material may be found in the following references:
Calvert, C. S. et al, 2001, “Method for Constructing 3-D Geologic Models by Combining Multiple Frequency Passbands”, U.S. Pat. No. 7,415,401.
Calvert, C., Foreman, L, Yao, T, and Bishop, G, 2004, “Spectral component geologic modeling: A novel approach for integrating seismic data into geologic models”, The Leading Edge, Vol. 23, No. 5, pp. 466-470.
Calvert, C. S. et al, “Forming a Model of a Subsurface Region”, U.S. Provisional Patent Application No. 61/140,161, filed Dec. 23, 2008.
Denver, L. E. and Phillips, D. C., 1992, “The Impact of Vertical Averaging on Hydrocarbon Volumetric Calculations-A Case Study”, in “Computer Modeling of Geologic Surfaces and Volumes” (D. E. Hamilton and T. A. Jones, editors), Amer. Assoc. Petroleum Geology, Tulsa, pp. 219-234.
Hardy, H. H. and Beier, R. A., 1994, “Integration of Large- and Small-Scale Data Using Fourier Transforms,” Proceedings of the Fourth European Conference on the Mathematics of Oil Recovery, Topic B: Heterogeneity Description and Assessment of Uncertainty, Roros, Norway.
Wu, J., Zhang, T., Journel, A., 2008, “Fast FILTERSIM Simulation with Score-based Distance”, Math Geosci., March 2008, Vol. 40, pp. 773-788.
Yao, Tingting, 1998, “Conditional Spectral Simulation with Phase Identification”, Mathematical Geology, Vol. 30, No. 3, pp. 285-308.
Ypma, T. J., 1995, “Historical Development of the Newton-Raphson Method”, SIAM Rev. Vol. 37, Issue 4, pp. 531-551.
Zhang T, Switzer P, Journel A., 2006, “Filter-based classification of training image patterns for spatial simulation” Mathematical Geology, Vol 38, No. 1, pp. 63-80.

### SUMMARY

A method is provided, wherein an expression is selected to approximate measurement-based values of a geologic attribute along at least one dimension of a subsurface formation as a function of position along the at least one dimension. Values for terms of the expression are determined such that the expression satisfies an objective function to within a predetermined amount. The objective function indicates a difference between outputs of the expression and the measurement-based values at similar points along the at least one dimension of the subsurface formation. The expression and the values of the terms of the expression are outputted. The outputting includes mapping the terms of the expression to represent the geologic attribute in the subsurface formation such that the geologic attribute is described at all locations in the subsurface formation using the expression and the values of the terms of the expression.

According to aspects of the disclosed techniques and methodologies, the expression may be a linear equation, a trigonometric equation, a logarithmic equation, a polynomial expression, a Boolean expression, or a fractal expression. The values for the terms of the expression may be determined using an iterative search function, which may be a Newton-Raphson method, a Conjugate method, a Jacobi method, a Gauss-Seidel method, a Conjugate Gradient method, a Generalized Minimal Residual method, or a Biconjugate Gradient method. The expression may be a first expression, and a second expression may be selected that, when combined with the first expression, approximates the measurement-based values as a function of position along the at least one dimension. Values for terms of the first and second expressions may be determined such that the combined first and second expressions satisfy the objective function to within the predetermined amount. The combined first and second expressions and the values of the terms of the combined first and second expressions may all be outputted. Alternatively, the expression may be a first expression, and additional expressions may be selected that, when combined with the first expression, approximate the measurement-based values as a function of position along the at least one dimension. Values for terms of the first expression and the additional expressions may be determined such that the combined first expression and additional expressions satisfy the objective function to within the predetermined amount. The combined first expression and the additional expressions, and the values of the terms of the combined first expression and the additional expressions, may be outputted. An additional term to be applied to the expression may be selected such that the expression approximates the measurement-based values as a function of position along the at least one dimension. Values may be determined for terms of the expression, including the additional term, such that the expression satisfies the objective function to within the predetermined amount. The expression and the terms of the expression, including the additional term, may be outputted. The additional term may be a trigonometric shape factor. The additional term may account for gradations in frequency along the at least one dimension, gradations in amplitude along the at least one dimension, or asymmetric function behavior along the at least one dimension. The objective function may be a root mean squared residual function or a sum of squared residual function. The presence of hydrocarbons in the subsurface formation may be predicted based on the outputted expression and the values of the terms of the expression, and hydrocarbons may be extracted from the subsurface formation. The geologic attribute may relate to porosity of the subsurface formation or permeability of the subsurface formation.

Another method is provided, wherein an equation is selected to approximate measurement-based values of a geologic attribute along a vertical axis of a subsurface formation as a function of vertical position. The equation includes a plurality of equation terms. A value for each of the plurality of equation terms is determined such that the equation satisfies an objective function to within a predetermined amount. A model of the subsurface formation is generated by solving the equation at a plurality of vertical positions using the plurality of equation terms. The model of the geologic formation is outputted. The outputting may include mapping the equation terms to represent the geologic attribute in the subsurface formation such that the geologic attribute can be described at all locations in the subsurface formation using the equation and the equation terms.

According to aspects of the disclosed techniques and methodologies, the measurement-based values of the geologic attribute may be obtained from measurements taken in a wellbore. The values for each of the plurality of equation terms may be determined using an iterative search function, which may be a Newton-Raphson method, a conjugate method, a Jacobi method, a Gauss-Seidel method, a conjugate gradient method, a generalized minimal residual method, or a biconjugate gradient method. The measurement-based values may be obtained at a plurality of locations with respect to the geologic formation, and an equation may be selected and the value for the respective each of the at least one equation term is determined at each of the plurality of locations. Values for each of the plurality of equation terms may be extrapolated through the subsurface formation to conform to a conceptual model of the subsurface formation, to thereby express values of the geologic attribute throughout the subsurface formation. Hydrocarbons may be extracted from the geologic formation based on the outputted model of the geologic formation.

Still another method is provided wherein, at each of a plurality of locations across a subsurface formation, an equation is selected that is configured to express, throughout a region of a subsurface formation, measured behavior of a geologic attribute as a function of position. Each of the equations has a plurality of equation terms associated therewith. For each equation, a value is determined for each of the plurality of equation terms such that outputs of each equation substantially match measured values of the geologic attribute throughout the region. An equation is established at an intermediate location between at least two of the plurality of locations. Equation terms are interpolated for the equation at the intermediate location using equation terms from equations selected at the at least two of the plurality of locations. A model of the subsurface formation is created using the selected equations and the established equation, with the respective plurality of equation terms. The model of the subsurface formation is outputted. The outputting may include mapping the equation terms to represent the geologic attribute in the subsurface formation such that the geologic attribute can be described at all locations in the subsurface formation using the equation and the equation terms.

Flow of hydrocarbons within the geologic formation may be predicted using the outputted model of the geologic formation. Hydrocarbons may be extracted from the geologic formation based on the outputted model of the geologic formation. Each region may include a wellbore from which values of the geologic attribute may be measured along the vertical region, and a mesh may be defined. The mesh may include nodes, at least one of the nodes being defined by a location of one of the wellbores. The selected equations and the established equation may have substantially similar form. The equation terms of the selected equations and the established equation may be varied. Each of the selected equations may include at least one of a linear expression, a trigonometric expression, a logarithmic expression, a polynomial expression, a Boolean expression, and a fractal expression. Determining a value for each of the plurality of equation terms may be performed by determining values of the equation terms for each equation such that the equation satisfies an objective function to within a predetermined amount. The objective function may indicate a difference between outputs of the equation and the measured values of the geologic attribute at similar positions. The objective function may be a root-mean-squared residual function or a sum of squared residual function. The value for each of the plurality of equation terms may be determined using an iterative search function. The outputting may include displaying the model of the subsurface formation.

Another aspect is a method of extracting hydrocarbons from a subsurface formation. An expression is selected to approximate measurement-based values of a geologic attribute along at least one dimension of the subsurface formation as a function of position along the at least one dimension. Values for terms of the expression are determined such that the expression satisfies an objective function to within a predetermined amount. The objective function indicates a difference between outputs of the expression and the measurement-based values at similar points along the at least one dimension of the subsurface formation. The expression and the values of the terms of the expression are outputted. A presence of hydrocarbons in the subsurface formation is predicted based on the outputted expression and the values of the terms of the expression. Hydrocarbons are extracted from the subsurface formation.

A computer program product is also provided. The computer program product has computer executable logic recorded on a tangible computer readable medium. The computer program product includes: code for selecting an equation to approximate measurement-based values of a geologic attribute along a direction in a subsurface formation as a function of position, wherein the equation includes a plurality of equation terms; code for determining a value for each of the plurality of equation terms such that the equation satisfies an objective function to within a predetermined amount; and code for generating a model of the subsurface formation by solving the equation at a plurality of positions using the plurality of equation terms.

### BRIEF DESCRIPTION OF THE DRAWINGS

The foregoing and other advantages may become apparent upon reviewing the following detailed description and drawings of non-limiting examples in which:

FIG. 1 is a chart showing a printout of a known wireline log;

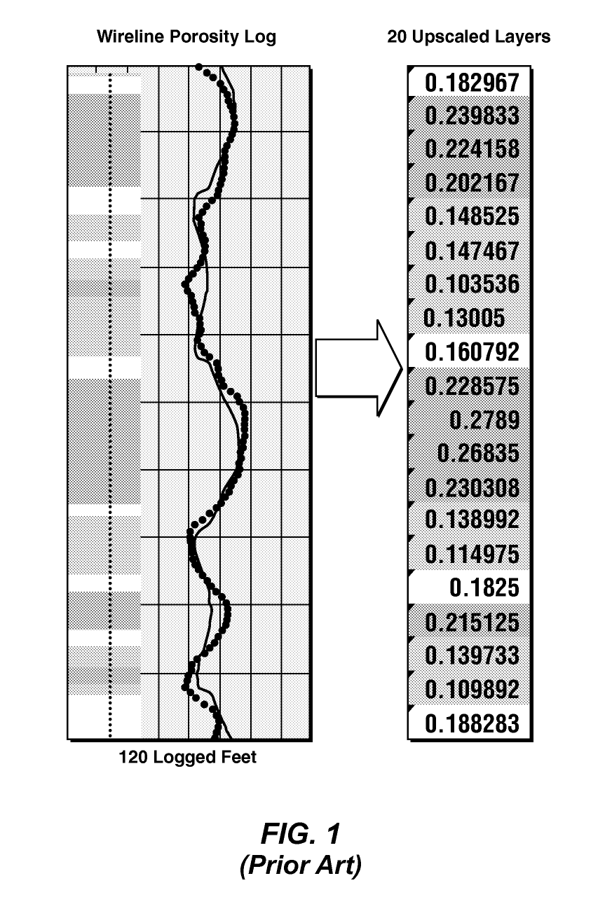

FIG. 2 is a graph showing a porosity log and a heterogeneity equation;

FIG. 3 is a graph showing a porosity log and a heterogeneity equation;

FIG. 4 is a graph showing a porosity log and a heterogeneity equation;

FIGS. 5A, 5B and 5C are graphs showing shape factors that may be used with a heterogeneity equation;

FIG. 6 is a graph showing a porosity log and a heterogeneity equation;

FIGS. 7A, 7B and 7C are graphs showing gradations that may be used with a heterogeneity equation;

FIG. 8 is a cross-section plot of a subsurface region showing porosity levels generated using actual and interpolated heterogeneity equations;

FIG. 9 is a cross-section plot of a subsurface region showing porosity levels generated using a heterogeneity equation extrapolated throughout the geologic unit;

FIG. 10 is a chart showing output values of a heterogeneity equation for various cell sizes;

FIG. 11 is a flowchart showing a method according to embodiments of the disclosed techniques;

FIG. 12 is a flowchart showing another method according to embodiments of the disclosed techniques;

FIG. 13 is a top plan view of a surface above a subsurface region;

FIGS. 14A and 14B are cross-section plots of a subsurface region showing the effects of enforcing a data-fitting parameter on interpolated heterogeneity equations;

FIG. 15 is a graph showing a wireline log; and

FIG. 16 is a schematic illustration of a computer system.

### DETAILED DESCRIPTION

Specific embodiments are described in the following detailed description section. To the extent the following description is specific to a particular embodiment or a particular use, this is intended to be for example purposes only and simply provides a description of the embodiments provided herein as representative examples of the invention. Accordingly, the disclosed aspects are not limited to the specific embodiments described below, but rather include all alternatives, modifications, and equivalents falling within the spirit and scope of the appended claims.

Some portions of the detailed description which follows are presented in terms of procedures, steps, logic blocks, processing and other symbolic representations of operations on data bits within a computer memory. These descriptions and representations are the means used by those skilled in the data processing arts to most effectively convey the substance of their work to others skilled in the art. In this detailed description, a procedure, step, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

Unless specifically stated otherwise as apparent from the following discussions, terms such as “selecting', “determining”, “indicating”, “outputting”, “combining”, “approximating”, “satisfying”, “predicting”, “generating”, “solving”, “establishing”, “interpolating”, “creating”, and “defining”, “mapping”, or the like, may refer to the action and processes of a computer system, or similar electronic computing device, that transforms data represented as physical quantities within the computer system's registers and memories into other data similarly represented as physical quantities within the computer system memories or registers or other such information storage, transmission or display devices. These and similar terms are to be associated with the appropriate physical quantities and are merely convenient labels applied to these quantities.

Embodiments disclosed herein also relate to an apparatus for performing the operations herein. The apparatus may be specially constructed for the required purposes, or it may comprise a general-purpose computer selectively activated or reconfigured by a computer program stored in the computer. Such a computer program may be stored in a computer readable medium. A computer-readable medium includes any mechanism for storing or transmitting information in a form readable by a machine, such as a computer (‘machine’ and ‘computer’ are used interchangeably herein). As a non-limiting example, a computer-readable medium may include a computer-readable storage medium (e.g., read only memory (“ROM”), random access memory (“RAM”), magnetic disk storage media, optical storage media, flash memory devices, etc.), and a computer-readable transmission medium.

Furthermore, the modules, features, attributes, methodologies, and other aspects of the disclosed methodologies and techniques can be implemented as software, hardware, firmware or any combination thereof. Wherever a component is disclosed as being implemented as software, the component can be implemented as a standalone program, as part of a larger program, as a plurality of separate programs, as a statically or dynamically linked library, as a kernel loadable module, as a device driver, and/or in every and any other way known now or in the future in the art of computer programming. Additionally, the invention is not limited to being implemented in any specific operating system or environment.

Example methods may be better appreciated with reference to flow diagrams. While for purposes of simplicity of explanation, the illustrated aspects may be shown and described as a series of blocks, it is to be appreciated that the aspects are not limited by the order of the blocks, as some blocks can occur in different orders and/or concurrently with other blocks from that shown and described. Moreover, less than all the illustrated blocks may be required to implement an example aspect. Blocks may be combined or separated into multiple components. Furthermore, additional and/or alternative aspects can employ additional blocks not shown herein. While the figures illustrate various actions occurring serially, it is to be appreciated that various actions could occur in series, substantially in parallel, and/or at substantially different points in time.

At the outset, and for ease of reference, certain terms used in this application and their meanings as used in this context are set forth. To the extent a term used herein is not defined below, it should be given the broadest definition persons in the pertinent art have given that term as reflected in at least one printed publication or issued patent.

As used herein, “displaying” is one method of outputting information. Displaying includes a direct act that causes displaying, as well as any indirect act that facilitates displaying. Indirect acts include providing software to an end user, maintaining a website through which a user is enabled to affect a display, hyperlinking to such a website, or cooperating or partnering with an entity who performs such direct or indirect acts. Thus, a first party may operate alone or in cooperation with a third party vendor to enable the reference signal to be generated on a display device. The display device may include any device suitable for displaying the reference image, such as without limitation a CRT monitor, a LCD monitor, a plasma device, a flat panel device, or printer. The display device may include a device which has been calibrated through the use of any conventional software intended to be used in evaluating, correcting, and/or improving display results (e.g., a color monitor that has been adjusted using monitor calibration software). Rather than (or in addition to) displaying the reference image on a display device, a method, consistent with the invention, may include providing a reference image to a subject. “Providing a reference image” may include creating or distributing the reference image to the subject by physical, telephonic, or electronic delivery, providing access over a network to the reference, or creating or distributing software to the subject configured to run on the subject's workstation or computer including the reference image. In one example, the providing of the reference image could involve enabling the subject to obtain the reference image in hard copy form via a printer. For example, information, software, and/or instructions could be transmitted (e.g., electronically or physically via a data storage device or hard copy) and/or otherwise made available (e.g., via a network) in order to facilitate the subject using a printer to print a hard copy form of reference image. In such an example, the printer may be a printer which has been calibrated through the use of any conventional software intended to be used in evaluating, correcting, and/or improving printing results (e.g., a color printer that has been adjusted using color correction software).

As used herein, “hydrocarbon extraction” or “extracting hydrocarbons” includes planning the location and timing of new wells, drilling wells, removing hydrocarbons from a hydrocarbon reservoir, managing production from existing wells, predicting production lifetimes of wells or hydrocarbon reservoirs at various extraction rates, and other similar activities.

As used herein, “hydrocarbon reservoir” includes reservoirs containing any hydrocarbon substance, including for example one or more than one of any of the following: oil (often referred to as petroleum), natural gas, gas condensate, tar and bitumen.

Heterogeneity equations (also called expressions) are convolved, or combined, mathematical functions that accurately represent the heterogeneity, or variability, of geologic features and properties within a geologic region or formation (or other stratigraphic element) as a function of position within the geologic region. Function terms of a heterogeneity equation, such as constants, scalars, factors, coefficients, and the like, are stored in a geologic model cell that represents the geologic region at a certain geographic location on or within the Earth. The function terms describe the trends, curvature, cyclicity, sharpness, and asymmetry of each cell property as a function of progress along the cell. Any geomodel cell containing such function terms can be divided into any arbitrary number of sublayers, and appropriate property values for each sublayer can be obtained simply by inputting the vertical position of each sublayer within the original cell's volume into the associated heterogeneity equation. According to the disclosed techniques, if each geomodel cell contains information that accurately describes the shape of the graphical representation of the wireline log that was its data source, that cell can be subdivided automatically into more finely layered cells. Each of those sublayers can be assigned a different property obtained by solving the heterogeneity equation that describes the wireline log shape.

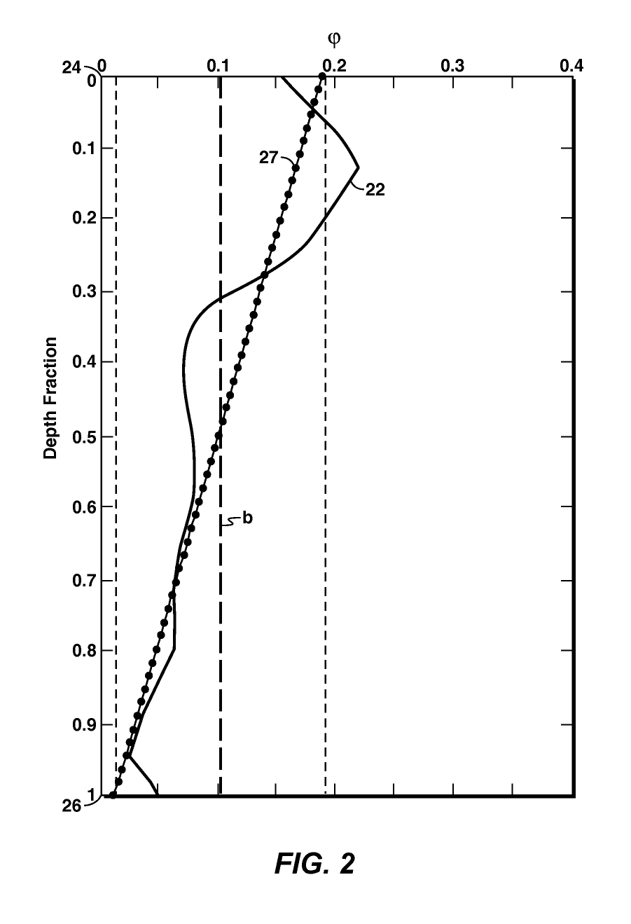

FIG. 2 is a plot showing wireline log data 22 representing a property such as porosity in a geologic region. According to the data, the value of the property tends to decrease from a top 24 of the geologic region to a bottom 26 of the geologic region. The property value may be therefore approximated using a linear equation, and the property value for any vertical position within the geologic region may be determined using three variables: a normalized slope of the behavior, the vertical position of the wireline log sample within the geologic region, and an average value of the property within the geologic region. Taking porosity (φ) as an example property, the porosity of the geologic region at any vertical position along the log data can be expressed as a linear equation of the form

φ=m(DF−½)+b [Equation 1]

where b equals the average porosity of the geologic region, m is the vertical trend normalized slope that describes the amount of porosity change from the top 24 to the bottom 26 of the geologic region (normalized to total bed thickness, Porosity Units per total unit thickness, where total thickness is defined as 1), and DF is a variable that describes the location within the geologic region expressed as a fraction of the total thickness of the region. The top of the region may be defined as DF=0 and the base of the region as DF=1. The ½ subtracted from DF locates the average porosity of the region in the center of the bed (at DF=0.5) when the equation is applied. This equation can be solved for any vertical position between the top and the bottom of the geologic region to provide an estimate of the porosity at that position.

A search algorithm, such as an iterative Newton's method (Ypma, 1995) may be used to find values for the slope m and average value b in Equation 1. In determining optimum values for slope and average value, a user-defined objective function such as a root-mean-squared function or the like may be used. A minimum value of the user-defined objective function indicates a minimum total error between outputs of Equation 1 and the measured wireline log data 22. Table 1 contains the best-fit linear equation terms for the example measured porosity log (FIG. 2), as determined by an iterative search algorithm known as the root-mean-square (RMS) algorithm.

TABLE 1

| m | b |
|---|---|
| −0.17403 | 0.100058 |

The normalized slope, which is the porosity change from the top of the region (DF=0) to the base of the region (DF=1), is negative because the porosity becomes smaller as DF increases to 1. These two numbers, when used with Equation 1, can be stored in one or more memory locations cooresponding to a single cell that defines the whole region. In FIG. 2, porosity values calculated using Equation 1 (plotline 27) illustrate the linear nature of Equation 1. A porosity value at any vertical position in the geologic region may be calculated regardless of how the region is divided.

Plotline 27 in FIG. 2 demonstrates a linear function that captures the overall decreasing trend of the wireline log data 42. However, plotline 27 only approximates the wireline log data 22. The wireline log data oscillates between the left and right side of plotline 27. This disagreement between the equation result and the measured porosity log can be reduced by applying a second function to represent the observed difference between the wireline log data and the output of Equation 1. As oscillating behavior can be described using trigonometric functions, a sine function may be selected as the second function in the heterogeneity equation. A sine function or other trigonometric function is only one example of a wide range of possible other functions that may be used, such as exponential, polynomial, logarithmic, Boolean, fractal, or the like, and the application is not intended to be limited to the use of only linear and trigonometric functions. Indeed, any type of function or expression may be used as required to achieve a best fit to the data.

Continuing the example of determining porosity from wireline log data 22, a sine function to be used in the heterogeneity equation may be expressed as

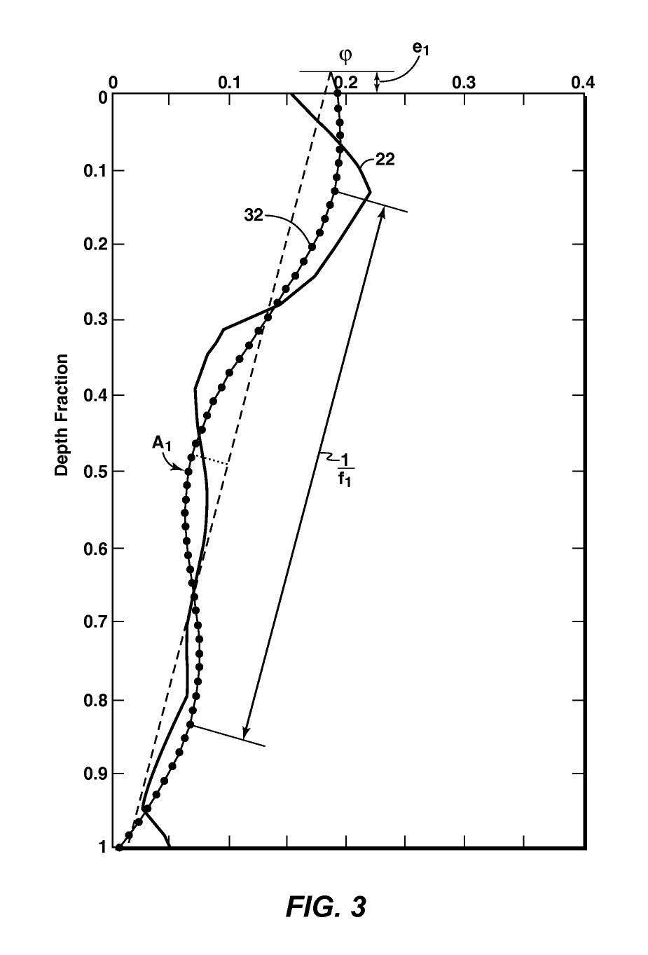

Sine1=A₁ sin(2πf₁(DF−e₁)) [Equation 2]

where e₁ describes the vertical position of the first sine function zero crossing (a “phase” term), f₁ is the number of full sine cycles that occur within the region (units are bed thickness/wavelength) and may be determined by taking the inverse of the average oscillation wavelength, it is the universal trigonometric constant 3.141593 . . . , and A₁ is the magnitude of porosity variation that the sine wave will add to the linear function. These variables are shown in FIG. 3. The 2π conversion factor is included in Equation 2 when calculations are performed in radians. A porosity heterogeneity equation incorporating both a linear function, such as Equation 1, and a trigonometric function, such as Equation 2, can be expressed as

φ=m(DF−½)+b+A₁ sin(2πf₁(DF−e₁)) [Equation 3]

As before, an iterative search algorithm may be used to find the equation constants that minimize an objective function that measures the total error between the heterogeneity equation result and the wireline log data. Table 2 shows values for terms in Equation 3 that best fit the wireline log data 22. The slope value m and the average function value b may differ from what is shown in Table 1 when the iterative search algorithm varies the values to obtain a better fit to the wireline log data.

TABLE 2

| m | b | A₁ | f₁ | e₁ |
|---|---|---|---|---|
| −0.17284 | 0.093844 | 0.029556 | 1.45565 | −0.03733 |

The root mean squared error of this example is 1.8 Porosity Units.

As shown at reference number 32 in FIG. 3, porosity values calculated using Equation 3 and the term values shown in Table 2 are a much better fit to wireline log data 22 when compared to Equation 1 (plotline 27), but there is still some mismatch between the measured data and the equation result. The wireline log data 22 is still observed to oscillate between the left and right side of line 32, suggesting that a second trigonometric function with a shorter wavelength (higher frequency) needs to be added to the equation.

The second trigonometric function may take the same form as Equation 2.

Sine2=A₂ sin(2πf₂(DF−e₂) [Equation 4]

In Equation 4, e₂ describes the vertical position of the second sine function zero crossing (a “phase” term), f₂ is the number of full sine cycles that occur within the region (units are bed thickness/wavelength) and may be determined by taking the inverse of the average oscillation wavelength, and A₂ is the magnitude of porosity variation that the second sine wave will add to the linear function. A heterogeneity function incorporating a linear portion (Equation 1) and first and second trigonometric portions (Equations 2 and 4) may be expressed as

φ=m(DF−½)+b+A₁ sin(2πf₁(DF−e₁))+A₂ sin(2πf₂(DF−e₂) [Equation 5]

An iterative search algorithm may be used to produce the function terms shown in Table 3, which best fit Equation 5 to the wireline log data 22 using a root-mean-squared (RMS) objective function or other objective function, such as the sum-of-squared residuals, sum of absolute values of residuals, or any other function that may be associated with residuals, as is known in the art of numerical analysis. As with Table 2, the linear function terms and the first trigonometric function terms may be adjusted by the search algorithm to create a best fit to the measured porosity log data when including a second sine function.

TABLE 3

| m | b | A₁ | f₁ | e₁ |
|---|---|---|---|---|
| −0.15455 | 0.091763 | 0.223104 | 1.82668 | 0.13695 |

| S₁ | A₂ | f₂ | e₂ | S₂ |
|---|---|---|---|---|
| 1 | 0.217729 | 1.9007913 | −.10108331 | 1 |

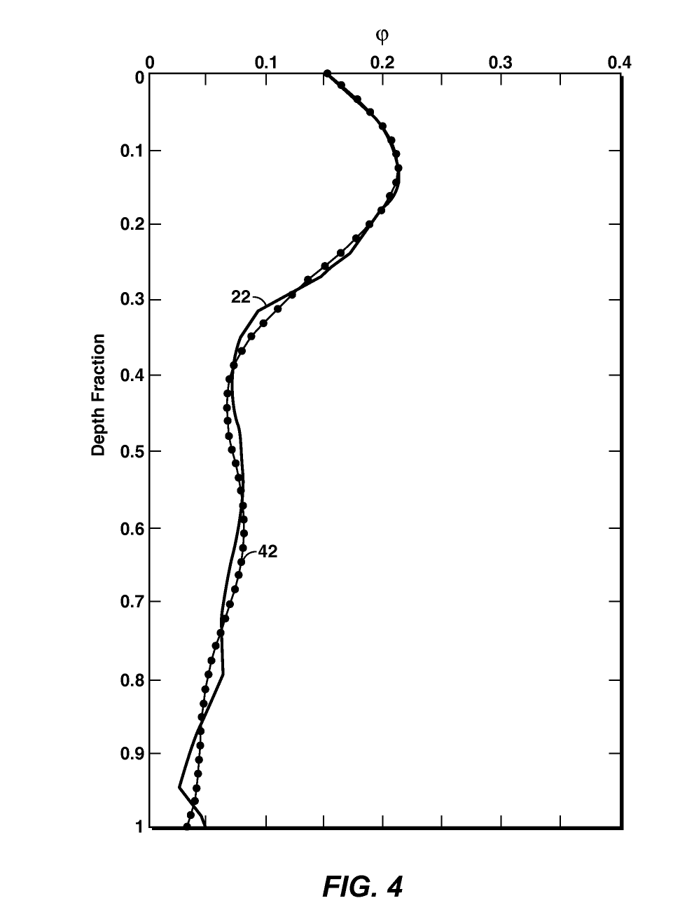

As shown at reference number 42 in FIG. 4, porosity values calculated using Equation 5 and the term values shown in Table 3 approximate wireline log data 22 much better than previously implemented equations and values. The root mean squared error of this example is 0.7 Porosity Units.

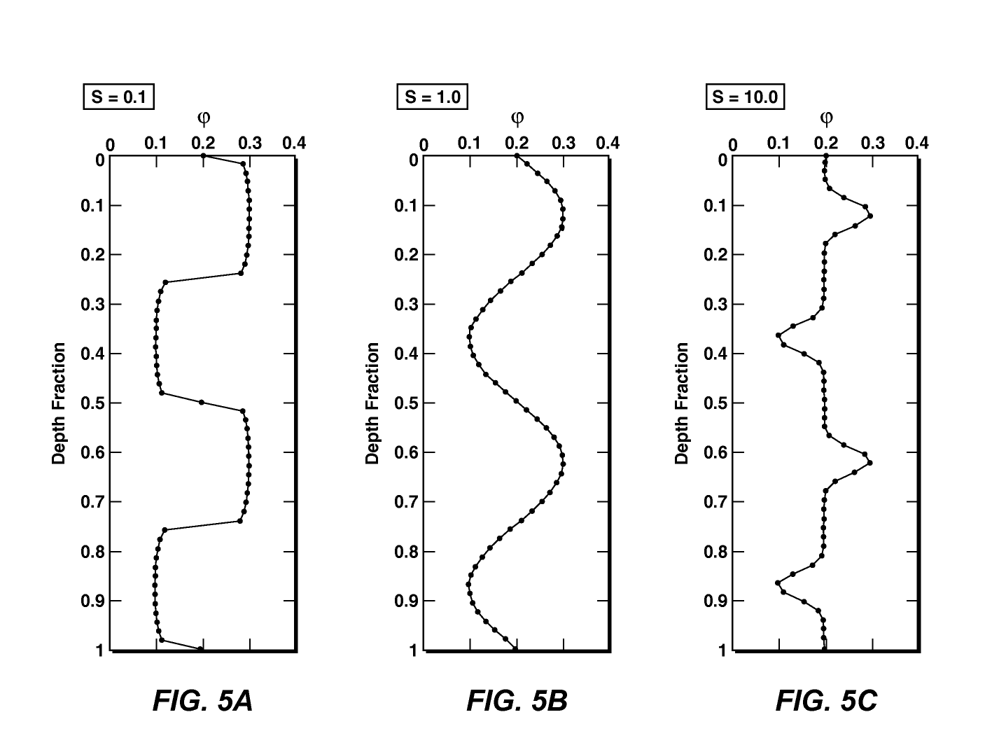

Table 3 contains values for S1 and S2, which are two parameters not present in Equation 5. S1 and S2 are exponent variables associated with the first and second trigonometric functions. S1 and S2 impose sharpness or bluntness onto their respective trigonometric function, and this additional term sometimes may produce a much better fit to the measured wireline log data. As shown in FIG. 5A, an S1 or S2 value of 0.1 serves to blunt a representative sine wave to which it is applied; as shown in FIG. 5C a value of 10 sharpens the sine wave; and as shown in FIG. 5B a value of 1 does not affect the sine wave. Other values of S1 or S2 may be used as well. In the example shown in FIG. 4, S1 and S2 are set to neutral values of 1.

A heterogeneity equation incorporating variables S1 and S2 may be expressed as

φ=m(DF−½)+b+A₁ sin(2πf₁(DF−e₁))^{S1}+A₂ sin(2πf₂(DF−e₂)^{S2} [Equation 6]

An iterative search algorithm may be used to produce the function terms shown in Table 4, which best fit Equation 6 to wireline log data 22 using an RMS objective function (or other objective function). The linear function terms and the first and second trigonometric function terms may be adjusted by the search algorithm to create a best fit to the wireline log data.

TABLE 4

| m | b | A₁ | f₁ | e₁ |
|---|---|---|---|---|
| 0.039138 | 0.096701 | 0.192971 | 0.82921 | −0.082891 |

| S₁ | A₂ | f₂ | e₂ | S₂ |
|---|---|---|---|---|
| 1.64226514 | 0.140066 | 1.0341174 | −0.41292874 | 1.730666 |

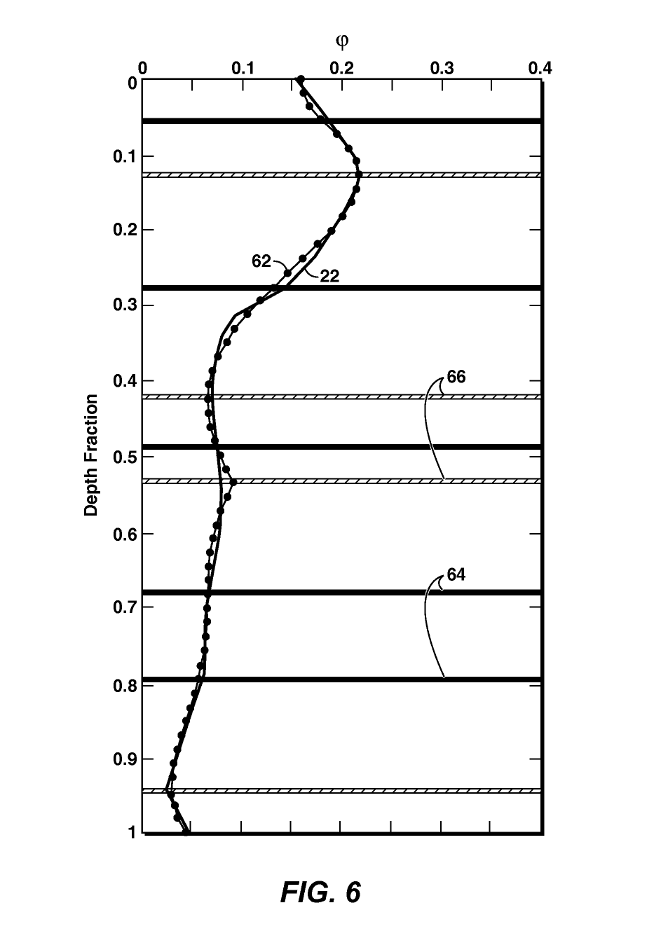

FIG. 6 shows a plot line 62 generated using Equation 6 and the function values in Table 4. Including exponential variables S1 and S2, as shown in FIG. 6, makes the heterogeneity equation result an even better fit with the wireline log data 62 than previous attempts. The RMS error of this example is now only 0.5 Porosity Units. The fit of plot line 62 to wireline log data is not perfect, but it is quite adequate for reservoir simulation purposes.

Certain values of exponents (e.g., non-zero even integers) change the value of an expression from negative to positive. To prevent exponent variables S1 and S2 from unnecessarily changing the sign of the trigonometric function with which they are associated, an algorithm or process such as Equation 7 may be used.

If

sin(2πf₁(DF−e₁))>0

then

Sine1=A₁ sin(2πf₁(DF−e₁))^{S1}

else

Sine1=−A₁ sin(2πf₁(DF−e₁))^{S1} [Equation 7]

By using the sign of the trigonometric function to determine the sign of the exponent-modified trigonometric function, Equation 7 ensures that the sign of a trigonometric function used in the heterogeneity equation is unaffected by an associated exponent variable.

Sometimes it is necessary to rebuild a geologic model with cells that are more finely layered in order to improve the portrayal of the reservoir rock heterogeneity. If sub-layering of the geologic region is needed, sensible candidate locations for sublayer boundaries can be found automatically by searching the heterogeneity equation result for inflection points, which are shown as dark lines 64 in FIG. 6, and points of local maxima and minima, which are shown as lighter lines 66 in FIG. 6. To limit the number of sublayers, thresholds of minimum curvature and minimum spacing can be used as selection criteria for the final layer boundaries.

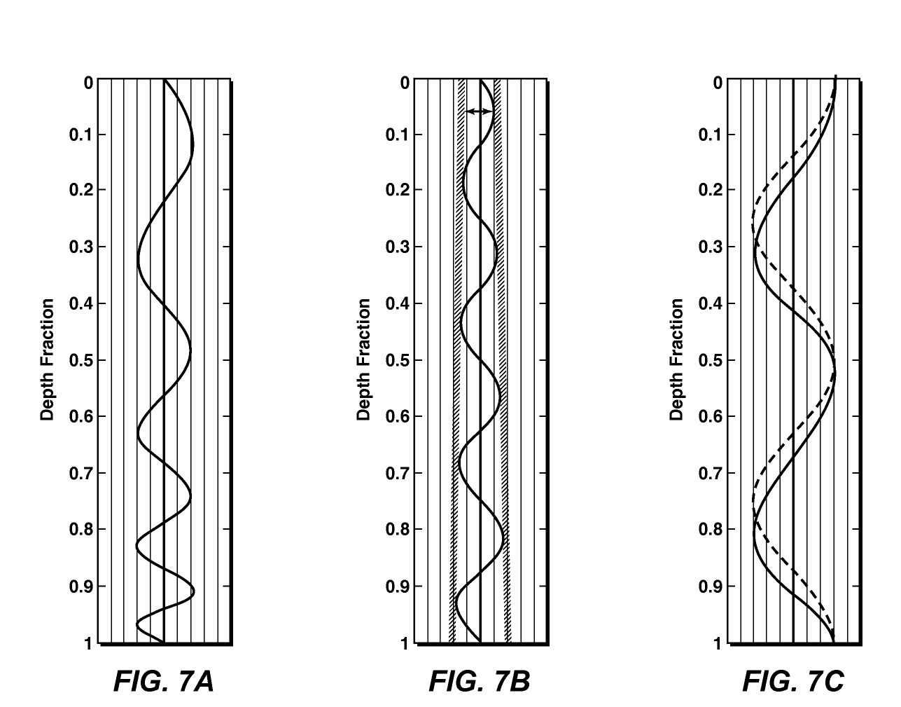

As previously discussed, it is possible to achieve reasonable accuracy to wireline log data. However, if further accuracy is required, additional functions or function modifications may be added to the heterogeneity equation according to the principles disclosed herein. For example, FIGS. 7A, 7B and 7C show three additional ways to modify a trigonometric function. As shown in FIG. 7A, the frequency of a trigonometric function may be varied as a function of vertical position. As shown in FIG. 7B, the amplitude of a trigonometric function may be varied as a function of vertical position. As shown in FIG. 7C, the waveform of a trigonometric function may be asymmetrically varied. Other function modifications may be used as well. Furthermore, the mathematical function components demonstrated above are only a small subset of the possible equation types that may implemented.

The examples disclosed herein have used porosity as a geologic property or parameter to be modeled, but other geologic properties or parameters may be modeled, such as maximum and minimum horizontal permeability, compass direction of the maximum permeability, vertical permeability, water saturation, rock type proportions, and states of strain or deformation. Additional properties or parameters that may be modeled include those characterizing different types of chemical and physical alterations to the rock since the time of deposition, quantifying fracturing and its effects on reservoir performance, and/or describing conditions unique to a specific field's geologic history.

Wireline log data may be acquired for hundreds or even thousands of feet in a geologic region. The geologic region may be subdivided into portions or parts, and a heterogeneity equation may be determined for each of the portions or parts, so that different heterogeneity equations may be derived from different stratigraphic intervals within the same vertical column of data.

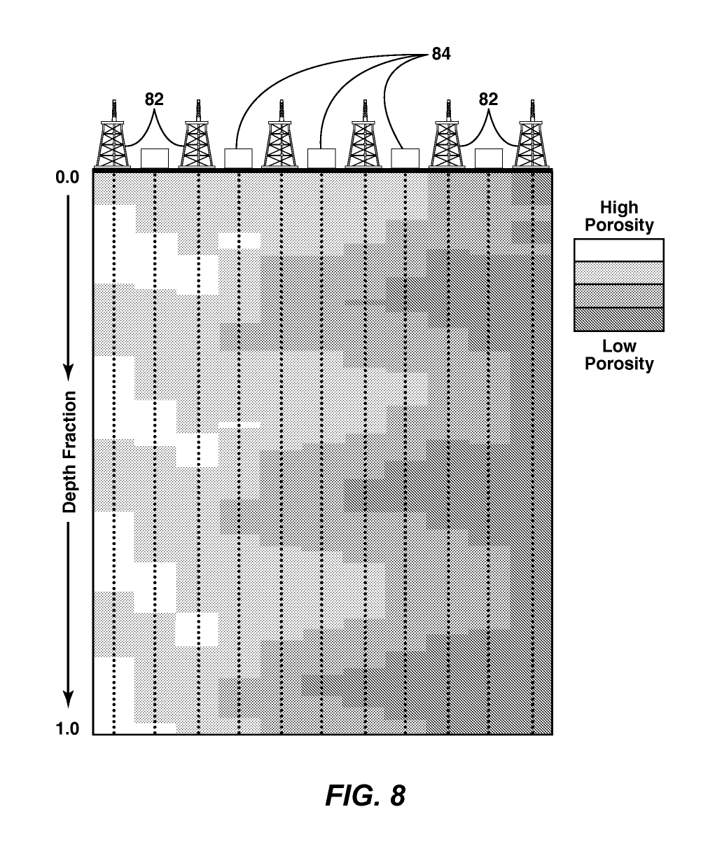

The processes disclosed herein may be repeated for multiple wells in an area, and values for geologic attributes (such as porosity) may be determined at each well location. Areal mapping of the heterogeneity equation function terms (such as m, b, f, e, A and S in the example Equations discussed above) between wells can then be performed, enabling the generation of vertical trends anywhere within the area in which the wells are located, and not just vertically at the well locations. For example, the average porosity of a bed may change gradually across an area, and this changing trend can be portrayed as a contour map or grid of Average Porosity. Simultaneously, the vertical slope of porosity may change from well to well and depositional cycles may be inclined so that on one side of the field a new a cycle appears at the base of the region. These lateral changes in normalized Slope, Frequency1, and Offset1 can also be contoured or gridded across the field area. All of the heterogeneity equation function terms can be interpolated laterally between the wells. Additionally, values of porosity (or any other function-modeled reservoir attribute or parameter) can be produced at any position within the modeled bed by solving the heterogeneity equation using the intermediate-state function terms interpolated between the well control locations. The cross-section plot shown in FIG. 8 illustrates the concept of interpolating the wellbore best-fit parameters between wells to fill a volume. This cross section could represent a slice through a 3-D volume in any direction. The vertical columns with derrick symbols 82 at the top represent real wells from which wireline porosity logs have been obtained. Porosity values within these columns have been obtained using the heterogeneity equation function terms as described herein. The columns with boxes 84 at the top represent vertical regions that fall between the wells. Porosity values in the boxed columns are calculated using the averages of heterogeneity equation function terms in adjacent real wells, but other known interpolation algorithms could be applied as well to obtain the porosity values in the boxed columns. Note that the shading (representing porosity) transitions smoothly from well to well in the cross section. Sensible geologic trends are portrayed across the model, such as decreasing porosity from left to right and the maintenance of four depositional sequence cycles.

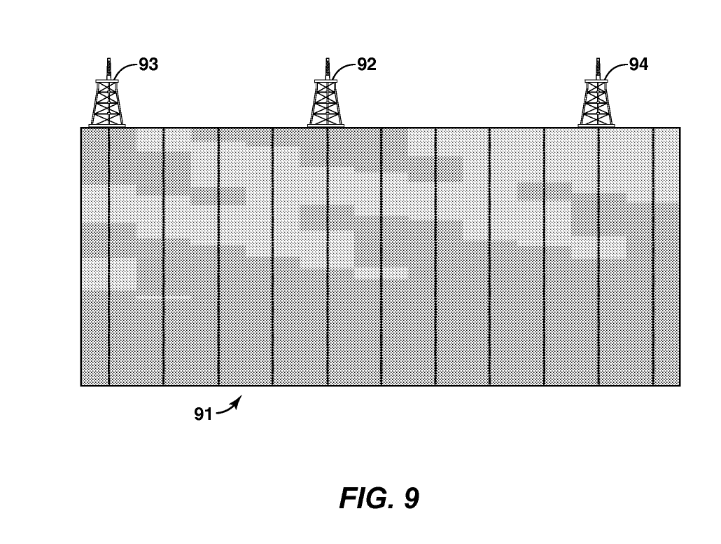

In some instances there is additional information that is known or assumed about a subsurface region or formation of interest. For example, a general sense of the lithology of the subsurface region may be known, and a conceptual model of the subsurface region could be constructed independent of wellbore data. In such a circumstance it may be possible to extrapolate geologic attributes for an area using data from a very small number of wellbores. FIG. 9 shows a cross-section of an area 91 with a single wellbore 92. A heterogeneity function and associated function terms are derived to best fit the data from wellbore 92 according to the inventive techniques and methodologies. Geologic attributes such as porosity may be evaluated at other positions in area 91, such as at 93 and 94, using the heterogeneity function derived using data from wellbore 92 by varying the associated function terms to match the known and/or assumed lithology or other information.

Some rules should be observed when interpolating function terms. For instance, a sine wave with a frequency of 2 cycles per unit depth will produce identical patterns with either a phase offset (e) of 0 or with a phase offset of 0.5. However, interpolating these phase offset values between wells may produce intermediate values that will introduce non-geologic discontinuities in the heterogeneity equation results. Common-sense guidelines to prevent this phenomenon will be further discussed herein.

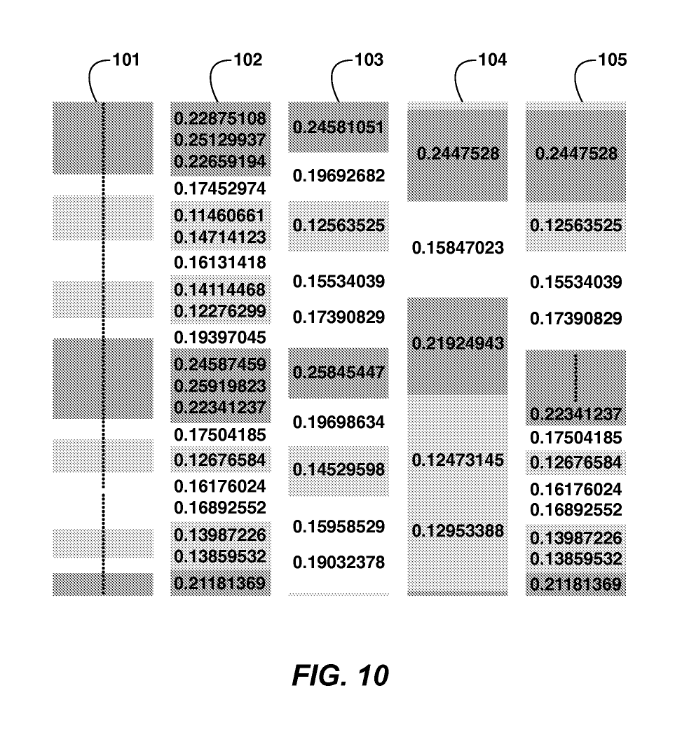

According to the disclosed techniques and methodologies, the information required to generate realistic sub-layer heterogeneity at any vertical location within the geologic layer is included in the heterogeneity equation function terms. A geologic model constructed according to the disclosed techniques and methodologies need only have one layer per geologic unit which contains all of the function terms. Additionally, it is no longer necessary to rebuild geologic models from scratch in order to resolve finer features. As shown in FIG. 10 a heterogeneity equation can be solved for any cell size by simply applying the equation at the desired vertical position. A heterogeneity equation-based model can be resampled at any arbitrary location within a geologic unit and a unique value corresponding to the source wireline log, or an interpolated estimation thereof, can be generated for that spot. This means that when a simulation model demonstrates a need for more (or less) detail, the information necessary to generate that level of detail is available in a single heterogeneity equation-based geologic model. For rigorous determination of effective flow properties, reservoir quality values for multiple locations within each simulation cell volume could be generated from the heterogeneity equations and subjected to flow based scale averaging.

Columns 101, 102, 103 and 104 in FIG. 10 depict how a heterogeneity equation may be solved for various cell sizes, where the cell size corresponds to a number of layers of equal thickness. However, it is not required that the layers and cell sizes in a geologic model have equal thickness. If, for example, a high degree of detail is required for only a portion of the geologic model, the model may be divided into a plurality of layers having different thicknesses. This is demonstrated in column 105, which has layers of varying thicknesses. The numeric values for a geologic attribute (such as porosity or permeability) are displayed in the layers of columns 101, 102, 103, 104 and 105. Such values may be easily obtained using the associated homogeneity equation along the entire length of the column.

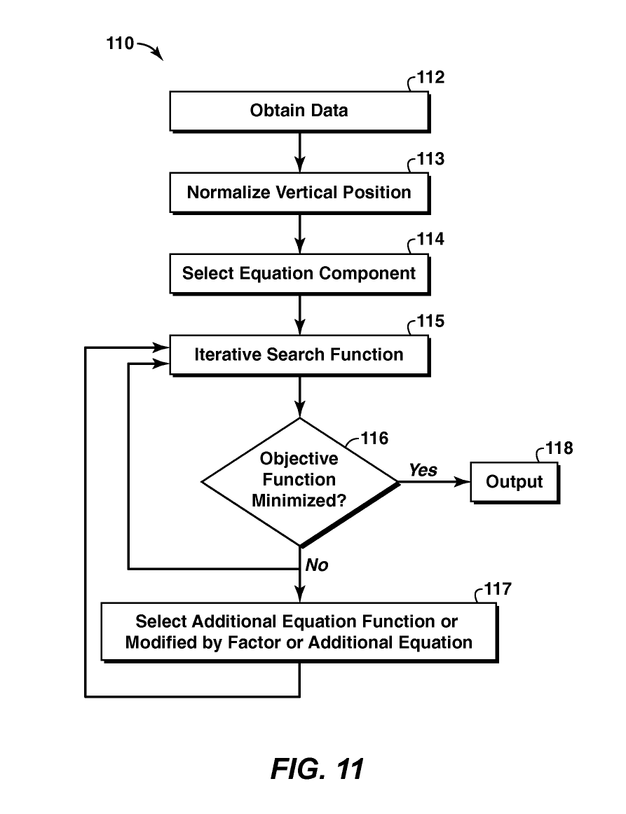

FIG. 11 is a flowchart depicting a method 110 according to embodiments of the disclosed techniques. At block 112 wireline log data is obtained from measurements made in a wellbore. The wireline log data may include values representative of one or more geologic attributes, such as porosity. At block 113 the vertical position of the wireline log data is normalized. This may be done by assigning an upper vertical position (shown as top 24 in FIG. 2) with a value of zero and a lower vertical position (shown as bottom 26 in FIG. 2) with a value of one. Vertical positions between the upper and lower vertical positions are assigned vertical position values representative of their respective distances therebetween.

At block 114 an expression, which may be an equation component, is selected to approximate the behavior of the geologic attribute (such as porosity) as exhibited in the wireline log data. The wireline log data may be inspected or analyzed to determine the proper equation component to select. For example, if the geologic attribute in the wireline log data demonstrates a general increase or decrease, a linear expression such as Equation 1 may be selected as an expression. If the geologic attribute oscillates about an average or neutral attribute value, a trigonometric expression such as Equation 2 may be selected. If the geologic attribute demonstrates a generally constant value but quickly increases or decreases at either the upper or lower vertical position, a logarithmic expression may be selected. Other types or forms of expressions or equations may also be selected according to the behavior of the wireline log data, which could include equations and/or expressions such as polynomials, fractals, Boolean expressions to capture discontinuities in the data, or any other equation designed to fit the data. The expression is selected to provide a geologic attribute value based on vertical position within the region or formation that is being modeled. The expression may include various terms, such as slope, frequency, amplitude, offset, or the like, as disclosed herein.

At block 115 the expression is analyzed using an iterative search algorithm or function, such as the Newton-Raphson method, Conjugate method, Jacobi method, Gauss-Seidel method, Conjugate Gradient method, Generalized Minimal Residual method, Biconjugate Gradient method, or other known search algorithms. The iterative search function is employed to find values for the various terms of the expression such that an output of an objective function is minimized. As previously discussed, the objective function may be a RMS function, or the like, that objectively indicates how closely the equation component approximates the wireline log data. At block 116 it is determined whether the iterative search algorithm has identified expression terms such that the objective function is minimized, or alternatively, minimized to a degree that the wireline log data is sufficiently approximated. This determination may be done by comparing a value of the objective function with a predetermined value. If the objective function is not minimized or not sufficiently minimized, further iterations of the iterative search function may be performed at block 115.

Alternatively, an additional expression may be added to the previously selected expression at block 117. The additional expression may be selected as previously described with respect to block 114. Additionally or alternatively, the expression may be modified by one or more factors such as added sharpness or bluntness (FIGS. 5A and 5B), frequency gradations (FIG. 7A), amplitude gradations (FIG. 7B), waveform asymmetry (FIG. 7C), and/or any other type of modification to provide a sufficiently close fit to the wireline log data. The method returns to block 115, where the modified or unmodified expression is used as an input to the iterative search function as previously described. Additional expressions and/or modifications are added as desired until it is determined in block 116 that the objective function is minimized or sufficiently minimized. At block 117 the method displays or otherwise outputs the expression or expressions (with modifications), with the associated component terms, as the heterogeneity equation that describes the behavior of the geologic attribute (such as porosity) according to the wireline log data. The output may include a mapping of the component terms that represents the geologic attribute in the subsurface formation such that the geologic attribute may be described at all locations in the subsurface formation using the heterogeneity equation and the associated component terms. Such mapping may be a computer-stored mapping or may be a numerically displayed (FIG. 10) and/or graphically displayed (FIG. 8) mapping. The output may be used to predict flow of hydrocarbons within a volume of interest and/or to conduct well management activities or techniques, including extracting hydrocarbons from a hydrocarbon reservoir.

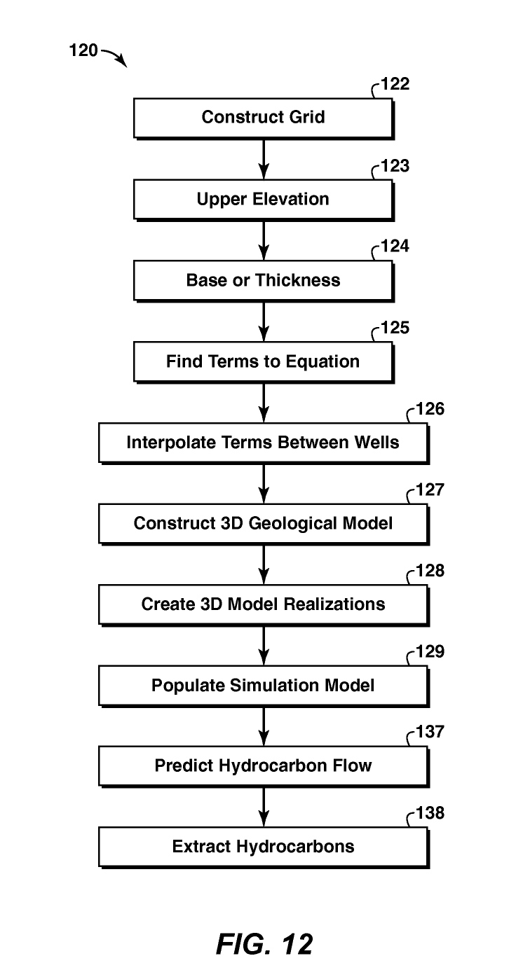

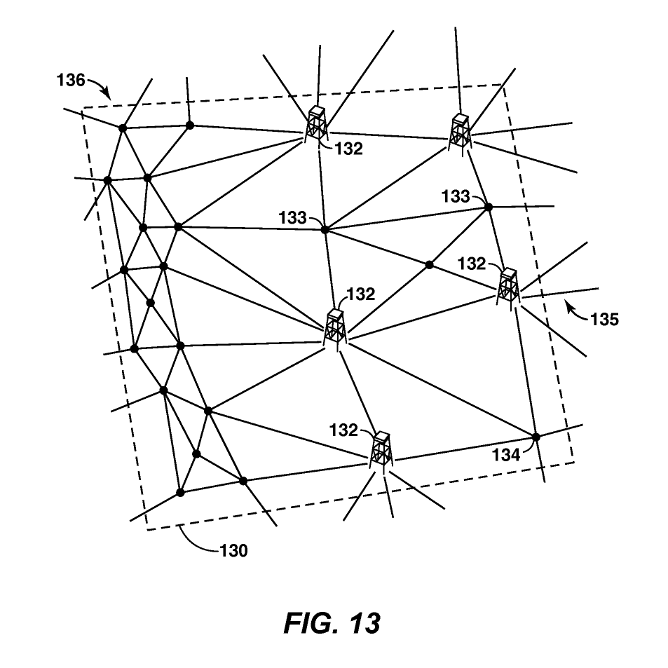

FIG. 12 is a flowchart showing a method 120 according to aspects of the disclosed techniques. Method 120 may be used to construct or create a model that predicts a value of a geologic attribute (such as porosity, permeability, or other attributes discussed herein) across a volume of interest, such as a subsurface geologic formation or region. An example subsurface formation is shown from above in FIG. 13 at reference number 130. Several wellbores 132 vertically intersect subsurface formation 130, and wireline log data may be obtained at each wellbore location. Although a heterogeneity equation and its associated terms may be derived as disclosed herein based on each set of wireline log data, it may be advantageous to construct a geologic model using predicted attribute values at locations between neighboring wellbores, such as at points 133 and 134. At block 122 a surface mesh (135 in FIG. 13), consisting of nodes in the X-Y (map) domain and node connector lines, is constructed for each geologic unit being represented in the volume of interest. Surface mesh 135 could be a regular mesh or grid (e.g., Cartesian or Voronoi) or an irregular grid, and in FIG. 13 is shown as being composed of Delaunay triangles. Node spacing should be such that rapid changes in lateral gradients can be captured. Mesh region 136 has closely spaced nodes relative to the remainder of mesh 135 and may represent a portion of the mesh where a rapid change in lateral gradient exists. It is helpful for nodes to exist at the locations of wellbores with wireline logs. Referring again to FIG. 12, at block 123 the upper elevation of the subsurface geologic unit being represented is stored on each node. Known methods of interpolating elevations onto meshes may be used. Node locations should be spaced closely enough to capture rapid changes of elevation gradient. At block 124, either the base of the geologic unit or the thickness of the geologic unit is stored for each node, again using known interpolation methods or techniques. This, in combination with the top of the unit established at block 122, allows calculation of the position of the geologic unit in 3-D space. Node locations should be closely spaced enough to capture rapid changes of unit thickness gradient.

At block 125, for each wireline log within the geologic unit, an iterative search algorithm, such as the Conjugate method, Newton's method, or the like, is used to find terms to a heterogeneity equation that minimize or sufficiently minimize an objective function, as previously explained. The heterogeneity equation may be determined using a method such as that shown in FIG. 11, or alternatively may have a pre-determined form, such as Equation 6. As previously discussed, the heterogeneity equation may contain one or more of linear functions, bilinear functions, trigonometric functions, exponential functions, logarithmic functions, multivariate polynomials, fractals, Boolean expressions, or other equations/expressions/functions that best fit the data. When the objective function is minimized or sufficiently minimized, each of the function terms for the heterogeneity equation is stored on the mesh node corresponding to the wellbore location. Common-sense rules may be applied to avoid false convergences and aliasing, e.g. ensuring that the period of sine functions is not smaller than twice the wireline log sample spacing. Also, angular terms like azimuth and phase should be kept as much as possible in the same quadrant, or at least not allowed to vary more than a reasonable angle per unit distance.

At block 126 the heterogeneity equation function terms are interpolated between wells using known methods such as inverse distance-squared weighting or kriging. In some cases external information (e.g., trends derived from seismic data, known geologic discontinuities such as faults, or the like) can be used to influence the outcome of interpolation algorithms. This may be performed using known techniques such as locally varying mean or co-located co-kriging. The mesh node locations may need to be refined to allow for the accurate capture of rapid changes in gradient in any of the terms being interpolated.

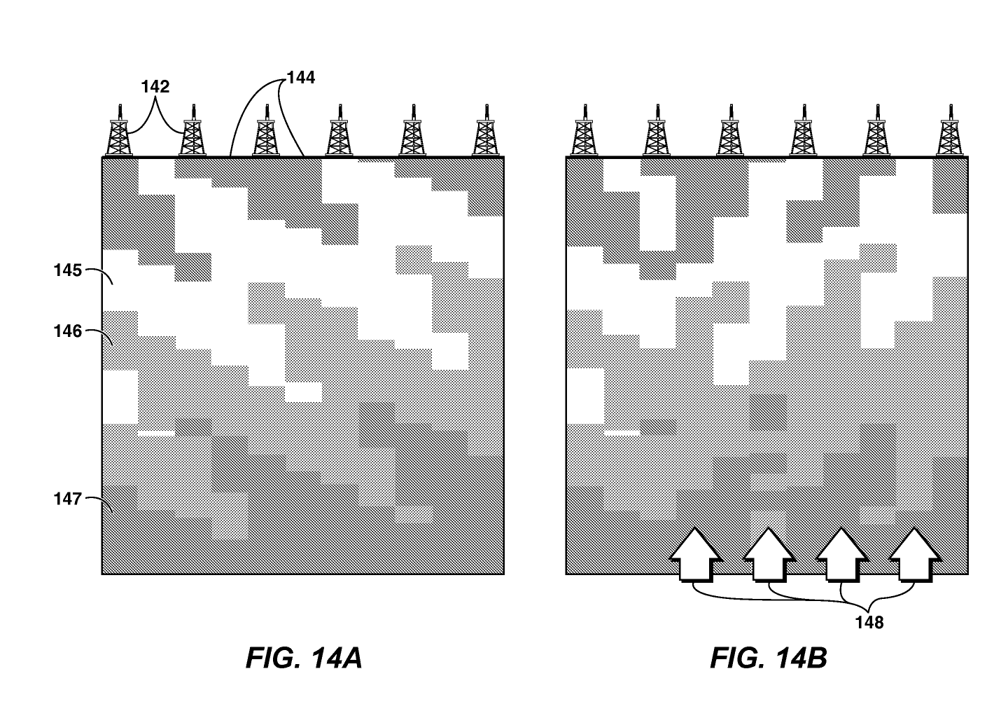

Certain rules should be applied when interpolating the heterogeneity equation function terms between wells. For example, a sine wave with zero radian phase offset is exactly equivalent to sine waves with phase offsets of +2Pi or −2Pi radians (here termed “phase-aliasing”). Interpolating angles between phase-aliased wells would make a full cycle of phase shift occur between wells with otherwise identical character. Phase should not be allowed to vary too rapidly, so the phase in some wells may need to be reset to an equivalent alias phase that is compatible with its neighboring wells. Similar issues exist with the azimuth of maximum permeability. FIG. 14A depicts a display output of a geologic model, where porosity has been modeled using one or more heterogeneous equations according to techniques disclosed herein. Porosity is modeled at well locations 142 and at interpolated locations 144 between the well locations. Low porosity is represented by lighter shaded regions 145, and higher porosity is represented by successively darker shaded regions 146, 147. Data-fitting parameter consistency is enforced, which prevents issues such as phase-aliasing or other aliasing. FIG. 14A demonstrates a model displaying geologically reasonable clinoform geometries. A trend of fining to the right is represented as well. In contrast, FIG. 14B depicts an output of a geometric model similar to FIG. 14A, but without data-fitting parameter consistency being enforced. In the interpolated locations indicated by arrows 148, discontinuities have been introduced, resulting in non-geologic geometries. Data-fitting parameter consistency techniques, such as anti-aliasing and the like, eliminate such inconsistencies and discontinuities.

Returning to FIG. 12, at block 127 a 3-dimensional geologic model is constructed by gathering together the component heterogeneity equation meshes representing every geologic unit in the volume of interest. It is not necessary (or desirable) for every geologic unit to be represented by meshes with nodes that stack up on identical X-Y coordinates, because the node locations of each horizon's mesh will have been optimized for the purpose of accurately modeling the most extreme curvatures in a multitude of function terms unique to that horizon. The composite of geologic unit elevations and thicknesses should completely fill the volume of interest with no gaps. Overlapping geologic units are allowed, but rules must be implemented that control which units should be preserved when represented volumes overlap. For example, when the base of one unit is the erosional top of a deeper unit, and the deeper unit has been modeled with its missing top restored for purposes of property prediction, the rules may state that the upper unit is preserved and the lower unit is truncated.

At block 128, realizations of the 3-D model are created by solving the heterogeneity equation at a multitude of locations defined by the user using the interpolated heterogeneity equation function terms. For computer visualization of a realization, heterogeneity below the resolution of the monitor screen need not be generated. This portion of the process is depicted in FIGS. 8 and 14. In the examples shown in both of these figures the heterogeneity equations have been sampled at 100 equally-spaced increments, creating cells more closely spaced than the original input well log sample spacing.

To populate a simulation model, at block 129 values for a geologic attribute at one or more locations within each simulation cell can be obtained using the heterogeneity equation with the interpolated heterogeneity equation function terms. These points can be mathematically averaged or upscaled using flow based upscaling. If coarser or finer simulation cells are needed, a different array of locations will be sent through the heterogeneity equation. As previously discussed the positions of candidate sublayer boundaries may be determined by processing the heterogeneity equation result for local minima, local maxima, and inflection points. The process of calculating heterogeneity equation results at various increment sizes within a geologic unit is illustrated in FIG. 10. The populated simulation model may be displayed, mapped, or otherwise output, and such output may be used to predict flow of hydrocarbons within the volume of interest (block 137) and/or to conduct well management activities or techniques, including extracting hydrocarbons from a hydrocarbon reservoir (block 138).

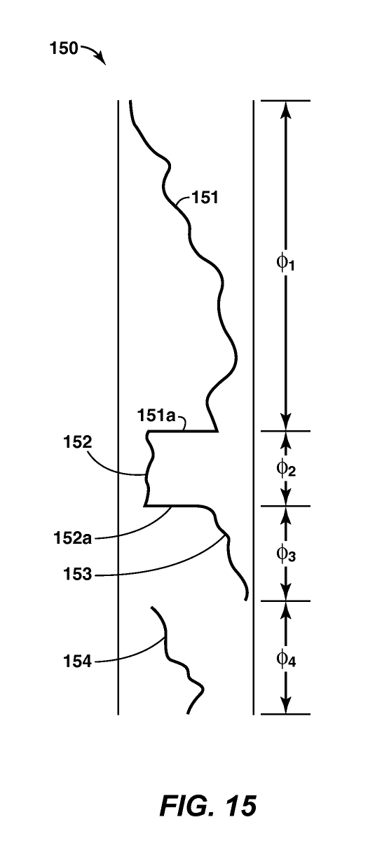

FIG. 15 depicts a graphical output representing a segment 150 of wellbore data. The graphical output describes discontinuous behavior of a geologic attribute (such as porosity) through segment 150 that may be difficult to describe using a single heterogeneity function. Such discontinuous behavior may be encountered at subsurface stratigraphic boundaries. Accordingly, multiple heterogeneity functions may be derived to approximate multiple portions of the segment of data. For example, as shown in FIG. 15, a first heterogeneity function φ₁ may be derived for a first portion 151 of segment 150 according to the inventive techniques and methodologies. A second portion 152 is separated from first portion 151 by an abrupt cutoff 151a that might be difficult to characterize in first heterogeneity function φ₁. Consequently, a second heterogeneity equation φ₂ is derived to approximate the wellbore data within second portion 152. A third portion 153 is likewise separated from second portion 152, and a third heterogeneity equation φ₃ is derived to characterize the third portion. A fourth heterogeneity equation φ₄ characterizes a fourth portion 154. Position along the wellbore determines which heterogeneity equation is to be used. The presence of discontinuities in the wellbore data is not the only circumstance in which multiple heterogeneity equations may be used as demonstrated in FIG. 15. Multiple heterogeneity equations may be used with any wellbore data that does not lend itself to using a single heterogeneity equation.

The embodiments disclosed herein refer to methods of deriving or creating a heterogeneity equation to express a geologic attribute as a function of vertical position. However, the disclosed methods and techniques may also be used when data is obtained from a non-vertically drilled well. Wireline log data obtained from a horizontally-drilled well may provide values of a geologic attribute (such as porosity) as a function of horizontal displacement. Wireline log data obtained from a well drilled at a non-horizontal and non-vertical angle may provide values of a geologic attribute as a function of horizontal and/or vertical displacement.

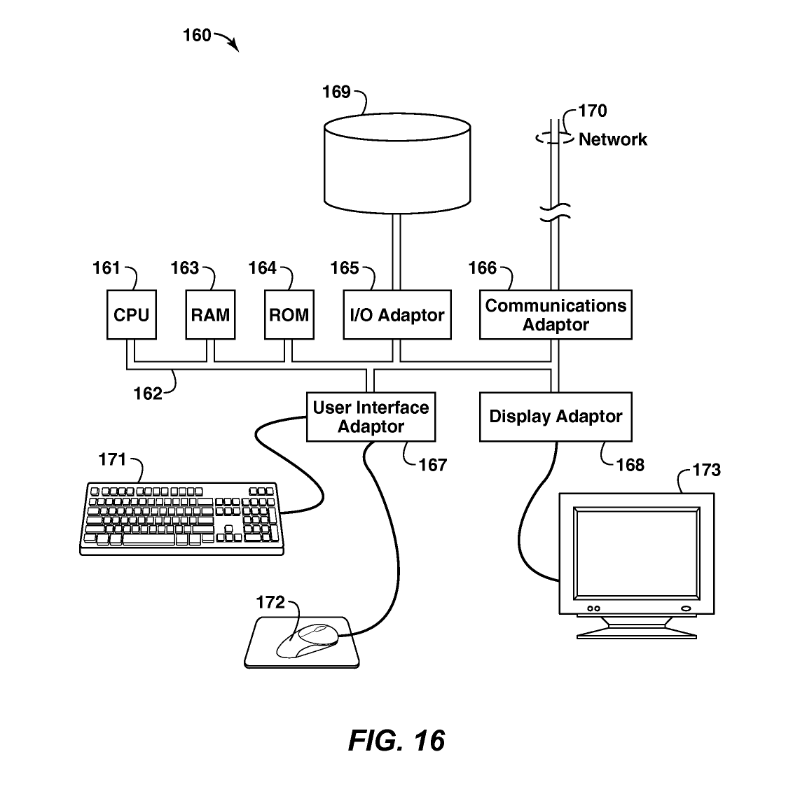

FIG. 16 illustrates a computer system 160 adapted to use the disclosed aspects. Central processing unit (CPU) 161 is coupled to a system bus 162. The CPU 161 may be any general purpose CPU, such as an Intel Pentium processor. However, the present techniques are not restricted by the architecture of CPU 161 as long as CPU 161 supports the certain operations as described herein. Bus 162 is coupled to random access memory (RAM) 163, which may be SRAM, DRAM, or SDRAM. ROM 164 is also coupled to bus 162, which may be PROM, EPROM, or EEPROM. RAM 163 and ROM 164 hold user and system data programs as is known in the art.

Bus 162 is also coupled to input/output (I/O) adaptor 165, communications adaptor 166, user interface adaptor 167, and display adaptor 168. The I/O adaptor 165 connects to one or more storage devices 169, such as one or more of a hard drive, a CD drive, a floppy disk drive, and a tape drive, to the computer system. The I/O adaptor 165 is also connected to printer (not shown), which allows the system to print paper copies of information such as documents, photographs, articles, etc. The printer may be a printer (e.g., inkjet, laser, etc.,), a fax machine, or a copier machine. Communications adaptor 166 is adapted to couple the computer system 160 to a network 170, which may be one or more of a telephone network, a local (LAN) and/or a wide-area (WAN) network, an Ethernet network, and/or the Internet network. User interface adaptor 167 couples user input devices, such as a keyboard 171, and a pointing device 172, to the computer system 130. User interface adaptor 137 may also provide sound output to a user via speaker(s) (not shown). Display adaptor 168 is driven by CPU 161 to control the display on display device 173.

In one aspect, the input data may be stored in disk storage device 139. The CPU 131 may retrieve the appropriate data from the disk storage device to perform the various calculations according to program instructions that correspond to the methods described herein. The program instructions may be written in a computer programming language, such as C++, Java and the like. The program instructions may be stored in a disk storage device. CPU 131 presents output primarily onto graphics display 143, or alternatively to a printer (not shown). CPU 131 may store the results of the methods described above on disk storage device 139 for later use and further analysis. Computer system 130 may be located at a data center remote from the reservoir. Additionally, while the description above is in the context of computer-executable instructions that may run on one or more computers, the subject matter as claimed also can be implemented in combination with other program modules and/or as a combination of hardware and software.

Aspects disclosed herein may be advantageously used to store properties of a reservoir without prior subdivision into layers. For example, porosity of a geologic region may be expressed as a heterogeneity equation, with the equation terms associated therewith stored in memory. When a porosity value for a location within the geologic region is desired, the vertical position of the location and the equation terms are entered into the heterogeneity equation, and the heterogeneity equation is easily solved. This is in contrast to known methods of referring to a stored porosity value for the location.

While the disclosed aspects may be susceptible to various modifications and alternative forms, the embodiments discussed above have been shown only by way of example. The disclosed aspects are not intended to be limited to the particular embodiments disclosed herein. The disclosed aspects include all alternatives, modifications, and equivalents falling within the spirit and scope of the appended claims.

What is claimed is:

1. A method comprising:
selecting an expression to approximate measurement-based values of a geologic attribute along at least one dimension of a subsurface formation as a function of position along the at least one dimension;
determining values for terms of the expression such that the expression satisfies an objective function to within a predetermined amount, the objective function indicating a difference between outputs of the expression and the measurement-based values at similar points along the at least one dimension of the subsurface formation; and
outputting the expression and the values of the terms of the expression, wherein the outputting includes mapping the terms of the expression to represent the geologic attribute in the subsurface formation such that the geologic attribute is described at all locations in the subsurface formation using the expression and the values of the terms of the expression.

2. The method of claim 1, wherein the expression is one of a linear equation, a trigonometric equation, a logarithmic equation, a polynomial expression, a Boolean expression, and a fractal expression.

3. The method of claim 1, wherein the values for the terms of the expression are determined using an iterative search function.

4. The method of claim 3, wherein the iterative search function is one of a Newton-Raphson method, a Conjugate method, a Jacobi method, a Gauss-Seidel method, a Conjugate Gradient method, a Generalized Minimal Residual method, and a Biconjugate Gradient method.

5. The method of claim 1, wherein the expression is a first expression, and further comprising:
selecting a second expression that, when combined with the first expression, approximates the measurement-based values as a function of position along the at least one dimension;
determining values for terms of the first and second expressions such that the combined first and second expressions satisfy the objective function to within the predetermined amount; and
outputting the combined first and second expressions and the values of the terms of the combined first and second expressions.

6. The method of claim 1, wherein the expression is a first expression, and further comprising:
selecting additional expressions that, when combined with the first expression, approximate the measurement-based values as a function of position along the at least one dimension;
determining values for terms of the first expression and the additional expressions such that the combined first expression and additional expressions satisfy the objective function to within the predetermined amount; and
outputting the combined first expression and the additional expressions and the values of the terms of the combined first expression and the additional expressions.

7. The method of claim 1, further comprising:
selecting an additional term to be applied to the expression such that the expression approximates the measurement-based values as a function of position along the at least one dimension;
determining values for terms of the expression, including the additional term, such that the expression satisfies the objective function to within the predetermined amount; and
outputting the expression and the terms of the expression, including the additional term.

8. The method of claim 7, wherein the additional term is a trigonometric shape factor.

9. The method of claim 7, wherein the additional term accounts for one of gradations in frequency along the at least one dimension, gradations in amplitude along the at least one dimension, and asymmetric function behavior along the at least one dimension.

10. The method of claim 1, wherein the objective function is one of a root mean squared residual function and a sum of squared residual function.

11. The method of claim 1, further comprising:
predicting a presence of hydrocarbons in the subsurface formation based on the outputted expression and the values of the terms of the expression; and
extracting hydrocarbons from the subsurface formation.

12. The method of claim 1, wherein the geologic attribute relates to one of porosity of the subsurface formation and permeability of the subsurface formation.

13. A method comprising:
selecting an equation to approximate measurement-based values of a geologic attribute along a vertical axis of a subsurface formation as a function of vertical position, wherein the equation includes a plurality of equation terms;
determining a value for each of the plurality of equation terms such that the equation satisfies an objective function to within a predetermined amount;
generating a model of the subsurface formation by solving the equation at a plurality of vertical positions using the plurality of equation terms; and
outputting the model of the geologic formation, wherein the outputting includes mapping the equation terms to represent the geologic attribute in the subsurface formation such that the geologic attribute can be described at all locations in the subsurface formation using the equation and the equation terms.

14. The method of claim 13, wherein the measurement-based values of the geologic attribute are obtained from measurements taken in a wellbore.

15. The method of claim 13, wherein the values for each of the plurality of equation terms are determined using an iterative search function.

16. The method of claim 15, wherein the iterative search function is one of a Newton-Raphson method, a conjugate method, a Jacobi method, a Gauss-Seidel method, a conjugate gradient method, a generalized minimal residual method, and a biconjugate gradient method.

17. The method of claim 13, wherein the measurement-based values are obtained at a plurality of locations with respect to the geologic formation, and wherein an equation is selected and the value for the respective each of the at least one equation term is determined at each of the plurality of locations.

18. The method of claim 13, further comprising extrapolating values for each of the plurality of equation terms through the subsurface formation to conform to a conceptual model of the subsurface formation, to thereby express values of the geologic attribute throughout the subsurface formation.

19. The method of claim 13, further comprising extracting hydrocarbons from the geologic formation based on the outputted model of the geologic formation.

20. A method comprising:
at each of a plurality of locations across a subsurface formation, selecting an equation that is configured to express, throughout a region of a subsurface formation, measured behavior of a geologic attribute as a function of position, each of the equations having a plurality of equation terms associated therewith;
for each equation, determining a value for each of the plurality of equation terms such that outputs of said each equation substantially match measured values of the geologic attribute throughout the region;
establishing an equation at an intermediate location between at least two of the plurality of locations;
interpolating equation terms for the equation at the intermediate location using equation terms from equations selected at the at least two of the plurality of locations;
creating a model of the subsurface formation using the selected equations and the established equation, with the respective plurality of equation terms; and
outputting the model of the subsurface formation, wherein the outputting includes mapping the equation terms to represent the geologic attribute in the subsurface formation such that the geologic attribute can be described at all locations in the subsurface formation using the equation and the equation terms.

21. The method of claim 20, further comprising predicting flow of hydrocarbons within the geologic formation using the outputted model of the geologic formation.

22. The method of claim 20, further comprising extracting hydrocarbons from the geologic formation based on the outputted model of the geologic formation.

23. The method of claim 20, wherein each region includes a wellbore from which values of the geologic attribute may be measured along the region, and further comprising defining a mesh, the mesh including nodes, at least one of the nodes being defined by a location of one of the wellbores.

24. The method of claim 20, wherein the selected equations and the established equation have substantially similar form.

25. The method of claim 20, wherein the equation terms of the selected equations and the established equation are varied.

26. The method of claim 20, wherein each of the selected equations include at least one of a linear expression, a trigonometric expression, a logarithmic expression, a polynomial expression, a Boolean expression, and a fractal expression.

27. The method of claim 20, wherein determining a value for each of the plurality of equation terms is performed by
for each equation, determining values of the equation terms such that the equation satisfies an objective function to within a predetermined amount, the objective function indicating a difference between outputs of the equation and the measured values of the geologic attribute at similar positions.

28. The method of claim 27, wherein the objective function is one of a root-mean-squared residual function and a sum of squared residual function.

29. The method of claim 27, wherein the value for each of the plurality of equation terms is determined using an iterative search function.

30. The method of claim 20, wherein the outputting includes displaying the model of the subsurface formation.

31. A method of extracting hydrocarbons from a subsurface formation, comprising:
selecting an expression to approximate measurement-based values of a geologic attribute along at least one dimension of the subsurface formation as a function of position along the at least one dimension;
determining values for terms of the expression such that the expression satisfies an objective function to within a predetermined amount, the objective function indicating a difference between outputs of the expression and the measurement-based values at similar points along the at least one dimension of the subsurface formation;
outputting the expression and the values of the terms of the expression;
predicting a presence of hydrocarbons in the subsurface formation based on the outputted expression and the values of the terms of the expression; and
extracting hydrocarbons from the subsurface formation.

32. A computer program product having computer executable logic recorded on a tangible computer readable medium, the computer program product comprising:
code for selecting an equation to approximate measurement-based values of a geologic attribute along a direction in a subsurface formation as a function of position, wherein the equation includes a plurality of equation terms;
code for determining a value for each of the plurality of equation terms such that the equation satisfies an objective function to within a predetermined amount; and
code for generating a model of the subsurface formation by solving the equation at a plurality of positions using the plurality of equation terms.
